(19) United States
(12) Patent Application Publication
(10) Pub. No.: US 2005/0144730 A1
(43) Pub. Date: Jul. 7, 2005

(54) Combination carabiner and wrench device

(76) Inventors: Launce Reed Barber, Chesterfield, VA (US); Thomas Richard Stokes, Yorktown, VA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/753,829

(22) Filed: Jan. 5, 2004

(51) Int. Cl. B25F 1/00

(52) U.S. Cl. 7/138

(57) ABSTRACT

A combination carabiner and wrench device is provided. The combination carabiner and wrench device may include a body and a gate incorporated within the body which may define a cavity when the gate is in a closed position. The carabiner and wrench device may further include a wrench portion with at least one moveable jaw.

### BACKGROUND

A carabiner device is shown in U.S. Pat. No. 6,223,372 issued May 1, 2001 entitled COMBINATION CARABINER AND TOOL DEVICE, the disclosure of which is hereby incorporated by reference. Other related devices are shown in U.S. Pat. Nos. 964,558; 1,039,260; 1,187,842; 1,635,649; 2,430,638; 4,122,569; 4,363,147; 5,212,844; 5,270,909; 5,329,675; 5,442,855; 5,463,798; 5,553,340; 5,581,834; 5,727,319; and 5,983,686, the disclosures of which are hereby incorporated by reference.

Carabiners are well known for their utility as a connecting tool. While carabiners have typically been used by individuals engaging in mountaineering or rock climbing, they are gaining popularity with users in the general population. Carabiners are generally loop shapes with a body in the form of a hook or c-shape of which the rear, the straight, and the central portions may be extended by curved loops, one at the top and one at the bottom, the free ends of which are connected, to close the loop by a gate. The gate may be pivotally mounted to permit passage of a rope (or other similarly-sized object) into the loop.

### SUMMARY

A combination carabiner and wrench device is provided. The combination carabiner and wrench device may include a body and a gate incorporated within the body which may define a cavity when the gate is in a closed position. The carabiner and wrench device may further include a wrench portion with at least one moveable jaw.

The advantages of the present invention will be understood more readily after a consideration of the drawings and the Detailed Description of the Preferred Embodiment.

### BRIEF DESCRIPTION OF THE DRAWINGS

FIG. 1 is a perspective view of a combination carabiner and wrench device with a gate, a wrench and a knife, where the gate and the wrench are shown in open positions and the knife is shown in a closed position according to an embodiment of the present disclosure.

FIG. 2 is a side view of the combination carabiner and wrench device of FIG. 1 with the wrench and the gate shown in closed positions and the knife shown in an open position.

FIG. 3 is perspective view of an alternative embodiment of a combination carabiner and wrench device, with a wrench and a knife shown in open positions according to an embodiment of the present disclosure.

FIG. 4 is a side view of another embodiment of a combination carabiner and wrench device shown with multiple tools in open positions according to an embodiment of the present disclosure.

FIG. 5 is a side view of yet another combination carabiner and wrench device including a wrench handle according to an embodiment of the present disclosure.

FIG. 6 is a side view of another combination carabiner and wrench device according to an embodiment of the present disclosure.

FIG. 7 is a side view of another combination carabiner and wrench device according to an embodiment of the present disclosure.

FIG. 8 is a side view of yet another combination carabiner and wrench device according to an embodiment of the present disclosure.

FIG. 9 is a side view of the embodiment of FIG. 8.

FIG. 10 is a side view of another combination carabiner and wrench device according to an embodiment of the present disclosure

FIG. 11 is a side view of the embodiment of FIG. 10 shown with a wrench and multiple tools in open positions.

### DETAILED DESCRIPTION OF THE PREFERRED EMBODIMENT

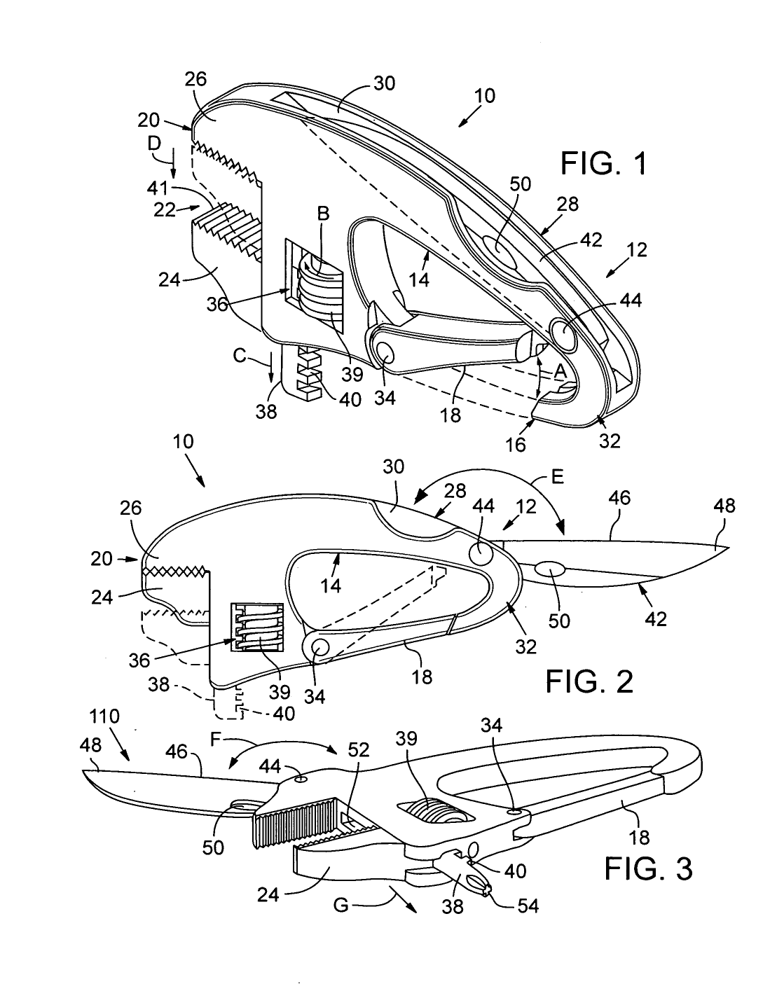

Referring to the drawings, and more specifically to FIG. 1, a combination carabiner and wrench device, also referred to herein as a carabiner wrench, is shown and indicated generally at 10. Carabiner wrench, as used herein, includes a combination carabiner and a wrench. Wrench, as used herein, includes a tool device that includes at least one moveable jaw. Exemplary tool devices that include at least one moveable jaw are wrenches, pliers, scissors, vises, pinchers, etc. The wrench, as used herein, may be any suitable tool having fixed or adjustable jaws, used for gripping, turning, or twisting objects such as nuts, bolts, or pipes. Wrench may further include pliers or other variously shaped hand tools having a pair of pivoted jaws used for holding, bending, or cutting.

Carabiner wrench 10 may include a body 12. As described in more detail below and as illustrated in the figures, body 12 may be any number of shapes. For example, body 12 may be a curvilinear body 12 or a substantially rectangular body. In the illustrated embodiment of FIG. 1, body 12 is shown as a curvilinear body. Body 12 may form an opening 14. For example, curvilinear body 12 may form an elongate opening or loop 14. It should be appreciated that body 12 may be of other suitable shapes defining an opening or cavity 14. For example, the body may be substantially triangular, circular, trapezoidal, etc. Similarly, the opening may be of any suitable shape.

For purposes of illustration, body 12 of FIG. 1 will be described in more detail. It should be appreciated that the description provided herein is for illustrative purposes and is not intended as a limitation. Specifically, in FIG. 1, body 12 may include a first-extended side 16 including a gate 18, a first-short side 20 which includes a wrench portion 22 with a moveable jaw 24 and a stable, or stationary jaw 26, a second-extended side 28 with a first storage slot 30, and a second-short side 32. Each respective side may include first and second connecting ends wherein the first-extended side or gate side 16 may be coupled to the first end of the first-short side 20 and to the second end of the second-short side 32. The second-extended side 28 may be coupled to the second end of the first-short side 20 and the first end of the second-short side 32.

As briefly described above, body 12 includes a moveable gate 18 that is adapted to be moved between opened and closed positions. In the illustrated embodiment of FIG. 1, gate 18 is disposed in the first-extended side 16; however the gate may be at any other suitable position. In some embodiments, the gate may be pivotally mounted to the body on a gate pivot pin 34 such that the gate swings in the direction of arrow A between an open position shown in FIG. 1, and a closed position shown in FIG. 2. Typically, during opening, gate 18 swings inward toward second-extended side 28, however in some embodiments, gate 18 may swing outward away from second-extended side 28. In some embodiments, gate 18 may be spring-loaded.

It should be appreciated that gate 18 may be locked in an open or a closed position. For example, gate 18 may be locked in a closed position when it engages the body. Any suitable gate-locking mechanisms may be provided, including, but not limited to, a sliding locking device, a rotating locking device, or any other known locking device.

As described above, the carabiner wrench device may include a wrench portion, including at least one moveable jaw. Wrench portion 22 of carabiner wrench 10 may be opened by selective adjustment of moveable jaw 24 relative to a stationary jaw. It should be appreciated that the stationary jaw may be part of the body of the carabiner wrench. Moreover, in some embodiments, there may be a second moveable jaw instead of a stationary jaw.

In FIG. 1, the wrench is shown in an open, or operational position wherein moveable jaw 24 is separated from stationary jaw 26. Moveable jaw 24 may be reversibly displaced into a variety of positions by manipulating a wrench adjustment 36.

In some embodiments, moveable jaw 24 may include a wrench adjustment post, or wrench post 38 which may further include one or more adjustment teeth 40. Adjustment teeth 40 may be configured to engage wrench adjustment 36 such that when wrench adjustment 36 is moved in the direction of arrow B, adjustment teeth 40 follow an adjustment thread 39 of wrench adjustment 36 and are moved off of wrench adjustment 36 in the direction of arrow C. This process may cause moveable jaw 24 to be separated from stationary jaw 26 in the direction of arrow D. Although only a few wrench open positions are illustrated, it should be appreciated that in the embodiment of FIG. 1, and some of the other embodiments to follow, the wrench may be positioned in any number of various open positions as allowed by the selective adjustment of moveable jaw 24.

While the wrench adjustment 36 shown in FIG. 1 selectively opens the wrench by a rotational motion other embodiments may include a wrench adjustment that may open the wrench by other suitable devices, including, but not limited to, a push pin, a spring, a slide-pin, etc. Furthermore, note that while arrow B is shown in the counterclockwise direction, other embodiments may include an adjustment 36 which may open a wrench portion 22 when turned in a clockwise direction. Although described in relationship to opening the moveable jaw, it should be appreciated that similar steps (albeit in reverse direction) may be taken to selectively close the moveable jaw.

Wrench portion 22 may be used for gripping, turning or twisting objects such as nuts, bolts, fasteners or pipes. Jaws 24 or 26 may include serrations 41 or other gripping, splicing or crimping surfaces. While in the embodiment of FIG. 1, the wrench portion 22 is located on first-short side 20 of body 12, other embodiments may include a wrench portion 22 located in other suitable positions, including positions on alternative body sides.

The embodiment of FIG. 1 further illustrates a storage slot for a knife or other tool(s). Specifically, body 12 includes a first storage slot 30 in the second-extended side 28. Storage slot 30 may be configured to receive a knife or knife blade 42. Knife blade 42 may be pivotally coupled to the body such that it rotates between a closed blade position (shown in FIG. 1) and an open blade position (shown in FIG. 2) about a tool pivot pin 44 in the direction of arrow E (shown in FIG. 2.) The knife blade may be locked in either an open or a closed position through the uses of known locking devices including latches, liner locks, sliding locks, spring locks, locking pins, etc. Although only a fully-extended open position and closed position are illustrated, it should be appreciated that in some embodiments, the knife may be positioned in any number of various open and/or closed positions.

In the open operational position shown in FIG. 2, knife 42 may be used as a cutting tool. Knife 42 may include a smooth cutting edge and/or a serrated sawing edge 46, and further may include a sharp point or tip 48. To use knife 42, a user may position knife blade 42 in an open blade position, lock the blade in the open blade position by some active or passive means, and grip body 12 by wrapping their fingers around second-extended side 28. In some embodiments, a user may grip both the first-extended side 16 and the second-extended side 28 when using the knife. Typically, second-extended side 28 becomes a temporary handle for knife blade 42. In some embodiments, the user may extend their hand through loop 14 in order to grip the second-extended side. Second-extended side 28 may include finger indents and hand mounts (neither of which is shown) to enable the user to maintain a secure grip on the second-extended side while using the knife.

The knife further may include an opening protrusion 50 to aid a user in opening the knife to the open blade position illustrated in FIG. 2. In other embodiments, the blade may include an opening lug, opening indentation, opening hole or similar device to aid the user in moving the blade to an open blade position.

FIG. 3 illustrates an alternative embodiment of a carabiner wrench at 110. In this embodiment, tool pivot pin 44 is disposed on the stationary jaw 26 of wrench portion 22. Accordingly, knife blade 42 pivots about tool pivot 44 in the direction of arrow F. As a result, when the knife is in the open operational position the knife is substantially adjacent to wrench portion 22, the reverse opening direction of that shown in the above described embodiment 10. As further illustrated in FIG. 3 moveable jaw 24 is opened when it is moved along a wrench slot 52 when adjustment 36 is rotated in the direction of arrow B. Rotation of adjustment 36 may cause teeth 40 to be displaced off of wrench adjustment 36 by moving wrench post 38 in the direction of arrow G through slot 52.

In the embodiment of FIG. 3, wrench post 52 is shown to include a screwdriver 54 at the post end distal to stationary jaw 26. This screwdriver may be used to place or remove screws or other devices with a corresponding female screw aspect. While a PHILLIPS® screwdriver head is shown extending from wrench post 52, any suitable tool may protrude from wrench post 52. For example, in alternative embodiments (not shown) wrench post 52 may include a flat-tip screwdriver, a ratchet screwdriver, a spiral ratchet screwdriver pick, a spiral ratchet screwdriver or other tool adapted to remove various devices including screws, nails, staples, tacks, etc.

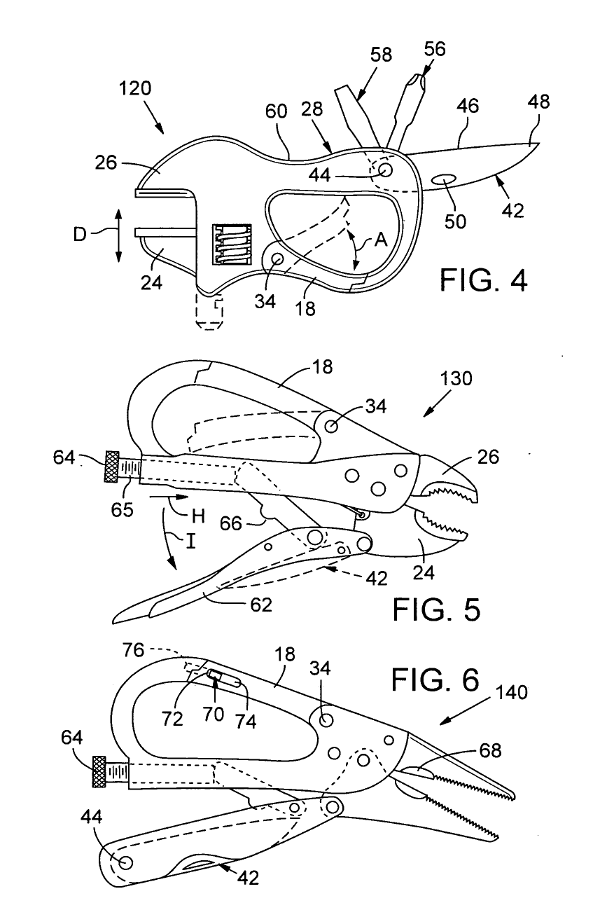

FIG. 4 shows another alternative embodiment of a carabiner wrench 120. In this embodiment, multiple tools, such as accessory or vanity tools, may be attached to tool pivot pin 44. The illustrated tools include a knife blade 42, a first pivot attached screwdriver 56, and a second pivot attached screwdriver 58; however any other suitable tool may be attached to tool pivot pin 44 or other pivot or attachment point. In some embodiments, the attached tools may be configured to fit within a first storage slot (as shown in FIG. 1). Moreover, in some embodiments, the tools may be contained with a second storage slot (not shown). The second storage slot may be adjacent the first storage slot or disposed elsewhere on the body, including a wrench handle, a stationary or moveable jaw, etc.

Tools which may be pivotally attached to carabiner wrench body 12 may include, but are not limited to, knife blades, can openers, scissors, files, screwdrivers, etc. Each of the tools 42, 56, 58, and/or others not here shown, may be pivotally connected to the device such that the tools are positionable in a closed position (as shown in FIG. 1) or in one or more open operable positions (such as the positions shown in FIG. 4.) In the illustrated embodiment, body 12, and more specifically, second-extended side 28, may include a tool engagement dip 60 configured to enable a user to pivot tools 42, 56 and 58 out from a storage slot and into an open operational position. The tools may include other known devices to aid in opening the tools, including opening lugs, liners, levers, etc. As with the knife blade described above, in embodiments 10 and 110, the tools may be configured to fold into a storage slot, forming a smooth, continuous body. Such tools may be locked in the open and/or the closed position using any suitable locking devices.

It should be appreciated that the shape of body 12 may vary according to user preference. For example, in some embodiments, the body may be substantially larger than the opening, while in other embodiments, the opening may be of significant size. Moreover, in some embodiments, surface area may be provided on the body for easier use and manipulation of the various tool devices, including use of the wrench. Each of the body characteristics, features and contours may affect the ease of use of the device.

FIG. 5 illustrates another alternative embodiment 130 for a carabiner wrench. Carabiner wrench 130 includes a wrench portion in the form of pliers, and a wrench handle 62. Wrench handle 62 may be an extended handle which extends beyond body 12. In some embodiments, wrench portion 22 may be adjusted by the manipulation of a wrench handle 62. Wrench handle 62 may be locked into an open position, wherein the handle is separated from the second-extended side 28 of body 12, or a closed position, wherein handle 62 is substantially adjacent to second-extended side 28, by locking pin 64. Wrench locking pin 64 may include incremental gradation markings 65 to aid the user in selectively opening the wrench to a desired position. Handle 62 may be connected to second-extended side 28 by a connector 66. Connector 66 may further include handle articulates which may be used in combination with locking pin 64 to aid in moving and locking mobile jaw 24 in a desired position.

Mobile jaw 24 may be moved away from stationary jaw 26 in the direction of arrow D when locking pin 64 is displaced in the direction of arrow H, which consequently displaces connector 66 and moves handle 62 away from second-extended side 28 in the direction of arrow I. It should be appreciated that while FIG. 5 shows a wrench locking pin device, other embodiments may use other wrench locking mechanisms including a spring device, a sliding device, a lever device, a ratchet device, a screw device, etc., to move and retain handle 62 in a desired position.

Handle 62 shows a portion of a knife blade 42 configured to be contained within a storage slot within the handle. As shown in previous embodiments 10, 110, and 120, blade 42 may be pivotally connected to the handle by a tool pivot pin 44 and may be moved into an open blade position by rotation in the direction of arrow E. While only a knife blade is shown, additional embodiments may include other tools pivotally retained within the handle including screwdrivers, files, scissors, etc.

FIG. 5 further illustrates a pair of curved jaws. Both the mobile jaw 24 and the stationary jaw 26 are curved such that they are adapted to grip objects, including round objects, such as pipes, nuts, round fasteners, etc. Due the curvature, the distal ends of jaws 24 and 36, the ends distal to second-short side 32, may not substantially meet or contact even in a closed position.

FIG. 6 shows an alternative embodiment 140 in which the jaws are flat (not curved). Wrench jaws 24 and 26 are flat similar to conventional pliers, such as needle-nose pliers, and thus the distal ends may substantially meet when the wrench is in a closed position. The proximal ends of jaw 24 and jaw 26, the jaw ends proximal to second-short side 32 may include cutting indentations 68 which may be used to grip objects, or alternatively, may be used to cut objects. It should be appreciated that the jaws may be of any suitable shape, including needle-nosed, flat-nosed, rounded, sharp, etc. Wrench handle 62 of the embodiment of FIG. 6 may contain a knife blade 42, or other tools as described above. Such tools may be attached to the wrench handle at a tool pivot pin 44.

As further illustrated in FIG. 6, gate 18 may be maintained in a closed position by a gate-locking mechanism or locking device 70. Locking device 70 is illustrated in an open position with locking slider 72 located entirely within the gate lock cavity 74, and out of the first-extended side lock cavity 76. With the locking device 70 in an open arrangement, gate 18 may be opened by the user by applying force on the side of the gate wherein the gate may be pivoted inward into loop 14 in the direction of arrow A. Embodiment 140 shown in FIG. 4 shows a gate-locking mechanism including a locking slider, herein referred to as a slider lock device, however, other embodiments may include other locking mechanisms, such as a spring lock device, a cuff lock device, a pin lock device, etc.

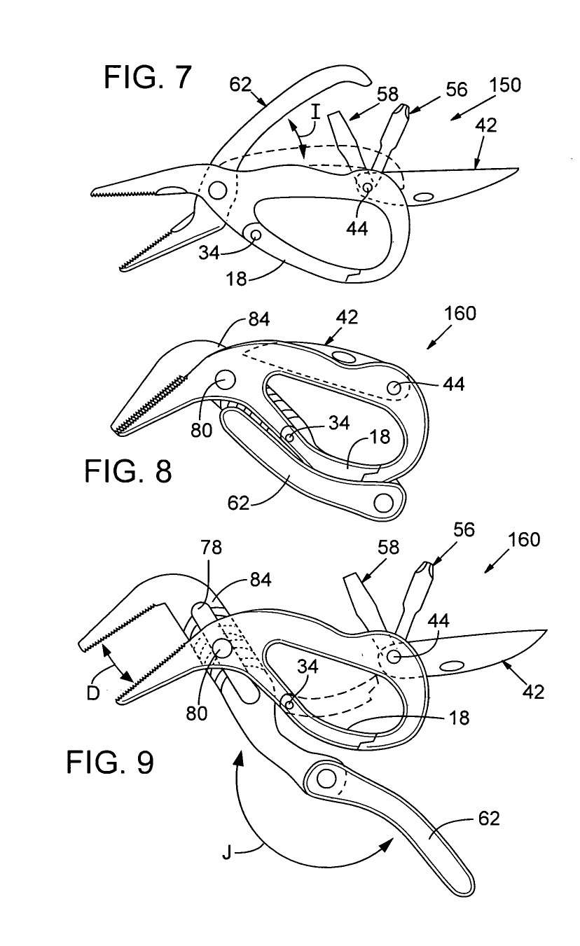

FIG. 7 illustrates an additional alternative embodiment 150 that has a wrench handle 62. Handle 62 may be configured to receive tools. Alternatively, the handle may be configured without tools. The wrench in FIG. 7 may be opened by the movement of handle 62 away from second-extended side 28 in the direction of arrow I, which moves mobile jaw 24 away from stationary jaw 26 in the direction of arrow D. As discussed above, in some embodiments, second-extended side 28 may be configured to contain tools such as knife blade 42 or pivot screwdrivers 56, 58.

FIGS. 8 and 9 show an alternative embodiment for a carabiner wrench at 160. FIG. 8 shows the carabiner wrench in the closed position and FIG. 9 shows the same embodiment in the open position. FIG. 9 illustrates an open position with the wrench 22 open and tools 42, 56 and 58 in an open position rotated outside of body 12. The moveable jaw 24 of this embodiment includes a jaw slot 78 which may be passed over a wrench lug 80 contained on stationary jaw 26. Attached to moveable jaw 24 may be a handle 62 which further may be pivotally connected to jaw 24 by a fastener 82. Handle 62 may be moved from the closed position of FIG. 8 to a closed position of FIG. 9 by movement in the direction of an arrow J. Fastener 82 may have a locking mechanism (not shown) to hold handle 62 into an open or a closed position.

Wrench 22 may be opened when the jaw slot 78 of moveable jaw 24 is slid over lug 80 of stationary jaw 26 in the direction of arrow D. Moveable jaw 24 may have gradation markings 84 that may guide a user in opening wrench 22 to a desired position. These markings may be on one or multiple sides of moveable jaw 24. The gate and any tools retained within a slot of second-extended side of this embodiment may be opened by the means described in the embodiments of FIGS. 1-7. It should be appreciated that in some embodiments, handle 62 may operate to lock the gate in a closed position. Thus, handle 62 may be in the same plane as the gate, thus preventing the release of the gate when handle 62 is in the closed position shown in FIG. 8. To access the gate, handle 62 must be moved to an open position, such as the position shown in FIG. 9. Alternatively, in some embodiments, handle 62 is in a different plane than the gate. In such embodiments, the handle may be substantially adjacent the side of the gate, thus enabling use of the gate even when the handle is in a closed position.

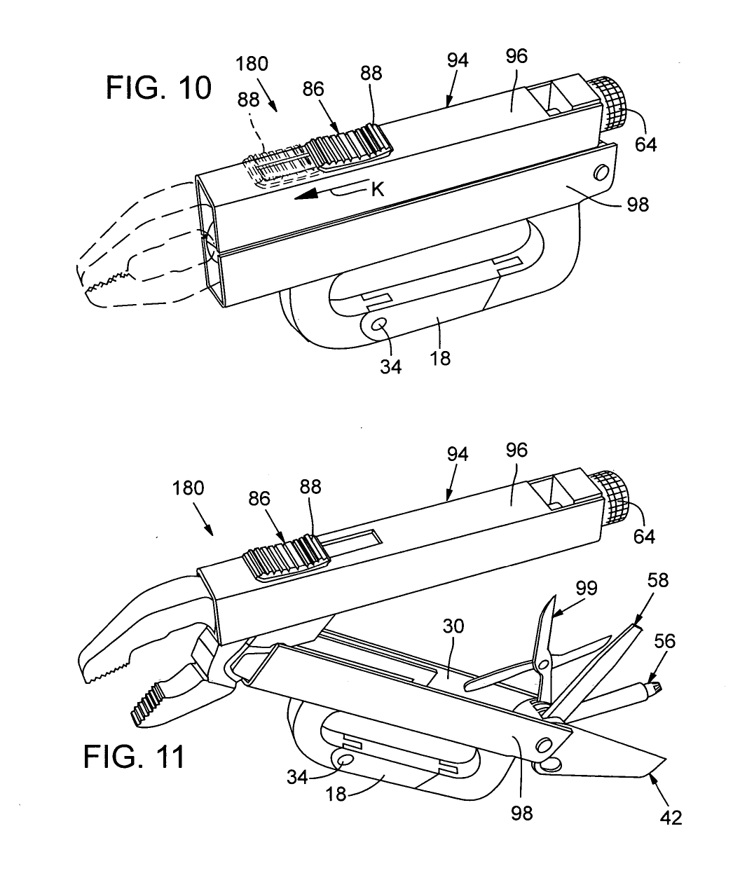

FIGS. 10 and 11 show yet another embodiment of a carabiner wrench 180 which includes two moveable jaws. FIG. 10 shows the carabiner wrench in a closed position and FIG. 11 shows the same embodiment in an open position. To open the wrench, a slider 86 with friction grips 88 may be moved in the direction of arrow K. This movement of slider 86 moves an upper moveable jaw, or upper jaw 90, and a lower moveable jaw, or lower jaw 92 in the direction of arrow K outside of a wrench handle 94. Wrench handle 94 further includes an upper handle piece 96 and a lower handle piece 98. These handle pieces may separate when wench jaws 90 and 92 are extruded outside of handle 94 in the direction of arrow K. The upper jaw 90 may be attached to and manipulated by upper handle 96, and the lower jaw 92 may be attached and manipulated by lower handle 98. Upper jaw 90 and lower jaw 92 may be separated from each other, and thus open the wrench, by movement of at least one of the upper handle piece 96 and/or the lower handle piece 98. The upper handle piece 96 may further include a locking pin 64 to assist a user in maintaining the wrench in a desired position. It should be appreciated that although illustrated as retractable and extendable jaws, in some embodiments the jaws may be maintained in an extended position outside of the handle.

Lower handle piece 98, which forms the second-extended side of carabiner body 12, may be configured to contain one or more tools within a storage slot 30 which may include a knife blade 42, a first screwdriver 56, a second screwdriver 58, scissors 99, or any other suitable tool. These tools may be attached at a tool pivot pin 44 and may be moved out of a closed position within the storage slot to an opened position by movement in the direction of arrow E.

Although the invention has been disclosed in its preferred forms, the specific embodiments thereof as disclosed and illustrated herein are not to be considered in a limiting sense, because numerous variations are possible. The subject matter of the invention includes all novel and non-obvious combinations and subcombinations of the various elements, features, functions, and/or properties disclosed herein. No single feature, function, element or property of the disclosed embodiments is essential. The following claims define certain combinations and subcombinations of features, functions, elements, and/or properties that are regarded as novel and nonobvious. Other combinations and subcombinations may be claimed through amendment of the present claims or presentation of new claims in this or a related application. Such claims, whether they are broader, narrower, equal, or different in scope to any earlier claims, also are regarded as included within the subject matter of the invention.

1. A combination carabiner and wrench device comprising:
a body;
a gate incorporated within the body, wherein the body defines a cavity when the gate is in a closed position; and
a wrench portion including at least one moveable jaw.

2. The combination carabiner and wrench device according to claim 1, including a knife blade pivotally connected to the body.

3. The combination carabiner and wrench device according to claim 2, wherein the knife blade rotates between an open position and a storage position such that in the storage position the blade is substantially confined in a storage slot within the body.

4. The combination carabiner and wrench device according to claim 1, wherein the wrench portion includes a stationary jaw.

5. The combination carabiner and wrench device according to claim 1, wherein the wrench portion includes two moveable jaws.

6. The combination carabiner and wrench device according to claim 1, wherein the wrench portion includes a wrench adjustment portion adapted to adjust a moveable jaw.

7. The combination carabiner and wrench device according to claim 1, wherein the wrench adjustment portion consists of a wrench adjustment post including adjustment teeth, said teeth adapted to engage adjustment threads.

8. The combination carabiner and wrench device according to claim 1, including a wrench locking mechanism.

9. The combination carabiner and wrench device according to claim 1, wherein the wrench locking mechanism is one of a wrench locking pin device, a spring device, a lever device, a ratchet device, and a screw device.

10. The combination carabiner and wrench device according to claim 1, including a wrench handle operatively attached to the body wherein the wrench handle is configured to move a moveable jaw.

11. The combination carabiner and wrench device according to claim 10, including one or more tools pivotally connected to the wrench handle.

12. The combination carabiner and wrench device according to claim 11, wherein the tools include one of a knife blade, a screwdriver, a file, a scissors, and a can opener.

13. The combination carabiner and wrench device according to claim 11, wherein the wrench handle further includes a wrench handle storage slot and the pivotally connected tool are configured to rotate between and open operational position and a storage position such that in the storage position the tools are substantially confined within the wrench handle storage slot.

14. The combination carabiner and wrench device according to claim 1, including tools pivotally connected to the body and configured to rotate between an open operational position and a storage position wherein the tools are substantially confined within a storage slot.

15. The combination carabiner and wrench device according to claim 14, wherein the tools may include one or more of a knife blade, a screwdriver, a scissors, a can opener, or a file.

16. The combination carabiner and wrench device according to claim 1, wherein the gate includes a gate locking mechanism capable of locking the gate the closed position.

17. The combination carabiner and wrench device according to claim 16, wherein the gate locking mechanism is one of a slider lock device, a spring lock device, a cuff lock device and a pin lock device.

18. A combination carabiner and wrench device comprising:
a gate configured to move between a closed position and a open position;
a wrench portion wherein at least one jaw is a moveable jaw;
a knife blade configured to pivotally move between an operational position and a storage position.

19. The combination carabiner and wrench device according to claim 18, including a body.

20. The combination carabiner and wrench device according to claim 19, wherein the body further comprises a first-extended side, a first-short side, a second-extended side, and a second-short side arranged such that when the gate is in the closed position the body defines a loop cavity.

21. The combination carabiner and wrench device according to claim 19, wherein the body defines a cavity when the gate is in a closed position.

22. The combination carabiner and wrench device according to claim 18, including a storage slot configured to substantially retain the blade in the storage position.

23. The combination carabiner and wrench device according to claim 18, wherein the storage slot is located opposite the gate, and is further located substantially adjacent to the wrench portion.

24. The combination carabiner and wrench device according to claim 22, including pivotally connected tools configured to rotate between an open operational position and a storage position wherein the tools are substantially retained within the storage slot.

25. The combination carabiner and wrench device according to claim 18, wherein the wrench portion includes two moveable jaws.

26. The combination carabiner and wrench device according to claim 18, wherein the wrench portion includes a stationary jaw.

27. The combination carabiner and wrench device according to claim 18, including a wrench handle configured to move a moveable jaw.

28. The combination carabiner and wrench device according to claim 27, including one or more tools pivotally connected to the wrench handle.

29. The combination carabiner and wrench device according to claim 18, wherein the wrench portion includes a wrench adjustment portion adapted to adjust a moveable jaw.

30. The combination carabiner and wrench device according to claim 18, including a wrench locking mechanism.

31. A combination carabiner and wrench device comprising:
a body;
a gate means;
a wrench means including at least one moveable jaw; and
a pivotally connected knife means.

32. The combination carabiner and wrench device of claim 31, wherein the gate means is adapted to pivotally rotate between and open and a closed position such that in a closed position the body defines a cavity.

33. The combination carabiner and wrench device of claim 31, wherein the wrench means is capable of gripping

34. The combination carabiner and wrench device of claim 31, wherein the wrench means includes and adjustment means for moving the moveable jaw to a desired position.
